(19) United States
(12) Patent Application Publication
(10) Pub. No.: US 2005/0075409 A1
(43) Pub. Date: Apr. 7, 2005

(54) Cell nucleation additive for polystyrene foam

(75) Inventor: Marie Condron Harfmann, Weddington, NC (US)

Correspondence Address: Carolina Compounding, Inc., 424 Amanda Drive, Weddington, NC, 28104, US

(73) Assignee: Carolina Compounding, Inc., Charlotte, NC (US)

(21) Appl. No.: 10/679,212

(22) Filed: Oct. 6, 2003

(51) Int. Cl. C08J 9/00

(52) U.S. Cl. 521/79; 521/145; 521/146; 521/139; 521/81

(57) ABSTRACT

Low density polystyrene foam is produced using polytetraflouroethylene particles to induce cell nucleation. The product shows improved gauge, improved blow up, and improved product strength.

### TECHNICAL FIELD

The present invention relates to the nucleation and cell size control of low density polystyrene foam. Low density is defined as less than 0.3 grams per cubic centimeter.

### BACKGROUND INFORMATION

Polystyrenic foams are widely used for applications ranging from industrial insulation to food packaging products. As is known in the industry, the properties of the foam vary considerably with the size and shape of the cells comprising the foam. Considerable effort has been expended on development of nucleating additives for the purpose of controlling the size and shape of those cells. Most commonly, mineral nucleators, such as talc, and chemical blowing agents, such as citric acid/sodium bicarbonate, are used. Historically, while inexpensive, mineral blowing agents have exhibited high open cell counts resulting in poor gas retention and inferior expansion in thermoforming. Such open cell counts are typically between 15% and 30% which can result in an inferior or heavier article. Chemical blowing agents, through liberation of atmospheric gases, cause rapid initial expansion of the foam and therefore the strength balance of the foam is affected. Again, the result is a less than optimal article when manufactured. It is therefore the object of the present invention to introduce a new nucleation additive that provides improved gas retention and expansion of the polystyrenic foam in thermoforming while also improving the strength and balance of the articles produced from said foam.

### SUMMARY OF THE INVENTION

The invention encompasses the production of low density polystyrene foam and products made thereof, using polytetraflouroethylene particles for cell size control. Such foam shows improved gauge, improved blowup in thermoforming, and improved performance of product. Product improvements include improved sidewall deflection strength, and improved impact strength.

### DESCRIPTION OF PRIOR ART

Johnson, et. al. disclose the use of polytetraflouroethylene particles for the nucleation of polyester foams. Johnson, et. al. did not however anticipate that such particles would be useful in producing polystyrene foam or that there would be unanticipated improvement in the properties of such foam.

### PREFERRED EMBODIMENT

In the preferred embodiment, polytetraflouroethylene particles of an average diameter of 2 microns are added to the polystyrene resin in a concentration of 0.1 to 0.3% by weight. The formulation may optionally contain colorants, antioxidants, flame retardants, or other additives. The mixture is fed into an extrusion line where the solids and melted and mixed. A blowing agent is injected into the melt. Such blowing agents are well known within the industry. The melt is further mixed and cooled and then extruded out of a die to form a useful shape. The preferred shape is flat sheet of a thickness between 0.040 inches and 0.200 inches which is collected in roll form. The roll is subsequently thermoformed to produce useful articles such as meat trays.

### EXAMPLE DATA

The following composition was fed into a tandem extrusion line:

| | Control | Sample |
|---|---|---|
| Nova 1210 | Balance | Balance |
| Regrind | 30% | 30% |
| CCI - ZNUC | 0.0% | 0.7% |
| Safoam P | 0.5% | 0.0% |
| Talc Concentrate (40% talc) | 1.0% | 0.0% |
| n-butane | 2.9% | 2.9% |
| Carbon dioxide | 0.35% | 0.35% |

This composition was fed into the primary extruder at a rate of 1180 lb/hr.

| | |
|---|---|
| Control | Sample |

Temperature

| | | | | |
|---|---|---|---|---|
| Primary Extruder | | | | |
| Zone 1 | 369 | F. | 370 | F. |
| Zone 2 | 384 | F. | 386 | F. |
| Zone 3 | 425 | F. | 425 | F. |
| Zone 4 | 450 | F. | 450 | F. |
| Zone 5 | 450 | F. | 450 | F. |
| Zone 6 | 462 | F. | 462 | F. |
| Zone 7 | 425 | F. | 425 | F. |
| Crossover | | | | |
| Adaptor | 425 | F. | 425 | F. |
| Screen Changer | 425 | F. | 425 | F. |
| Adaptor | 425 | F. | 425 | F. |
| Melt Pump | 425 | F. | 425 | F. |
| Adaptor | 425 | F. | 425 | F. |
| Secondary Extruder | | | | |
| Zone 1 Coolant | 90 | F. | 90 | F. |
| Zone 2 Coolant | 90 | F. | 90 | F. |
| Die | | | | |
| Zone 1 | 275 | F. | 275 | F. |
| Zone 2 | 275 | F. | 275 | F. |
| Zone 3 | 275 | F. | 275 | F. |

Pressures

| | | | | |
|---|---|---|---|---|
| Primary Extruder Exit | 2260 | psi | 2250 | psi |
| Gear Pump Inlet | 1908 | psi | 1900 | psi |
| Gear Pump Exit | 3830 | psi | 3900 | psi |
| Die | 2630 | psi | 2650 | psi |

Machine Conditions

| | | | | |
|---|---|---|---|---|
| Primary Extruder | | | | |
| Speed | 123 | rpm | 126 | rpm |
| Current | 173 | amps | 180 | amps |
| Melt Pump | | | | |
| Speed | 60.0 | rpm | 60.0 | rpm |
| Secondary Extruder | | | | |
| Speed | 16.5 | rpm | 16.5 | rpm |
| Current | 79.0 | amps | 80.0 | rpm |

Using the above conditions, product polystyrene foam sheet was produced. The sheet was thermoformed into a 25S meat tray. Test data for the sheet and trays is listed below.

Sheet Test Date

| Test Method | Control | Sample | Improvement |
|---|---|---|---|
| Density | 0.078 g/cc | 0.075 g/cc | 4.0% |
| Gauge | 0.125 inches | 0.135 inches | 8.0% |
| Expansion¹ | 0.255 inches | 0.275 inches | 7.8% |
| Blow Up Ratio | 204% | 204% | |

Tray Test Data

| | Weight | Thickness |
|---|---|---|
| Control | 19.5 grams | 0.210 inches |
| Sample | 19.6 grams | 0.215 inches |

Impact Test²

| | Day 1 | Day 7 | Day 14 | Day 21 |
|---|---|---|---|---|
| Control | 16.5 | 14.5 | 11.5 | 9.0 |
| Sample | 17.0 | 16.5 | 15.5 | 14.5 |
| Improvement | 3% | 14% | 35% | 61% |

Instron Sidewall Test³

| | Cross Direction | | Machine Direction | |
|---|---|---|---|---|
| | Day 1 | Day 7 | Day 1 | Day 7 |
| Control | 3.667 lbf | 4.554 lbf | 5.772 lbf | 6.375 lbf |
| Sample | 6.099 lbf | 6.783 lbf | 6.043 lbf | 6.557 lbf |
| Improvement | 66% | 49% | 5% | 3% |
| | Day 14 | Day 21 | Day 14 | Day 21 |
| Control | 4.550 lbf | 4.425 lbf | 6.530 lbf | 6.821 lbf |
| Sample | 6.021 lbf | 6.198 lbf | 6.842 lbf | 7.343 lbf |
| Improvement | 32% | 40% | 5% | 8% |

¹This is a measurement of gauge after thermoforming oven without closing mold.
²A 283 gram dart is dropped from varying height. The sample passes at the height of drop where at least 6 of the 10 samples tested do not break.
³Sample is clamped into Instron clamps and crushed using a constant crosshead speed during closure.
Results are measured at 1 inch of travel.

In summary, significant improvements were observed in gauge, expansion, impact performance, and machine direction sidewall strength. However, dramatic improvements in cross direction sidewall strength were observed which were totally unexpected.

1. A low density polystyrene foam composition containing polytetraflouroethylene particles for nucleation and cell size control, and said composition having a density less than 0.3 grams per cubic centimeter.

2. The composition of claim 1, wherein the polytetraflouroethylene particles are between 1 and 10 microns in size.

3. The composition of claim 1, wherein the polytetraflouroethylene particles are added to the product at a concentration of between 0.1 and 3.0%.

4. The composition of claim 1, wherein the said composition contains a rubber phase.

5. The composition of claim 1, wherein said composition contains a chemical blowing agent.

6. The composition of claim 5, wherein the chemical blowing agent comprises a combination selected from a group consisting of citric acid and bicarbonate, and citric salt and bicarbonate.

7. (cancelled)

8. (cancelled)

9. (cancelled)

10. (cancelled)

11. (cancelled)

12. (cancelled)

13. (cancelled)

14. (cancelled)

15. A low density polystyrene foam composition comprising a masterbatch composition containing polytetraflouroethylene particles for nucleation and cell size control, and a polystyrene carrier resin, said composition having a density less than 0.3 grams per cubic centimeter.

16. The composition of claim 15, wherein the polytetraflouroethylene particles are between 1 and 10 microns in size.

17. The composition of claim 15, wherein the polytetraflouroethylene particles are added to the product at a concentration of between 0.1 and 3.0%.

18. The composition of claim 15, wherein said composition contains a rubber phase.

19. The composition of claim 15, wherein said composition contains a chemical blowing agent.

20. The composition of claim 19, wherein the chemical blowing agent comprises a combination selected from a group consisting of citric acid and bicarbonate, and citric salt and bicarbonate.
